(19) United States
(12) Patent Application Publication
(10) Pub. No.: US 2014/0329060 A1
(43) Pub. Date: Nov. 6, 2014

(54) Construction Panel and Manufacture Thereof

(71) Applicant: SAINT-GOBAIN PLACO SAS, Suresnes (FR)

(72) Inventors: Guillaume Vivier, Bagneux (FR); Thomas Barraud, Aubervilliers Cedex (FR); Valentina Dodson, Coventry (GB); Nicholas Jones, Coventry (GB); Jonathan Young, Cornwall (GB)

(73) Assignee: SAINT-GOBAIN PLACO SAS, Suresnes (FR)

(21) Appl. No.: 14/364,682

(22) PCT Filed: Dec. 12, 2012
(86) PCT No.: PCT/EP2012/075251

§ 371 Date: Jun. 12, 2014

(30) Foreign Application Priority Data
Dec. 12, 2011 (GB) 11212461.1

(51) Int. Cl. E04B 1/14; B32B 38/08; B32B 37/12; B32B 7/12; B32B 7/14

(52) U.S. Cl. CPC E04B 1/14; B32B 7/12; B32B 7/14; B32B 37/1292; B32B 38/08; B32B 2250/02; B32B 2250/03; B32B 2255/26; B32B 2260/046; B32B 2607/00
USPC 428/198; 428/195.1; 156/290; 427/259; 427/428.01

(57) ABSTRACT

A panel for use in building construction comprises a substrate board having two opposed faces. A lamina is secured to a first one of the faces of the substrate board by means of one or more regions of bonding between the lamina and the board. The one or more regions of bonding cover a total area that is less than 20% of the total interfacial area between the lamina and the board.

The present invention relates to panels for use in building construction and the manufacture thereof. In particular the present invention relates to panels for providing partitions to which items such as sinks, televisions, or radiators may be affixed.

Light-weight panels such as plasterboard (e.g. gypsum plasterboard), polystyrene board and fibreboard are commonly used to provide partitions within buildings. Their advantages for this application include the fact that they are light and quick to install.

However, in certain cases, such light-weight panels may have the drawback that they are not strong enough to support fixtures (e.g. sinks, televisions, radiators, fire extinguishers, shelves and any other item that requires attachment to the panel). In such cases, the weight of the fixture may cause the fixing means (e.g. screws) to be pulled out of the panel, such that the fixture falls away from the partition.

Typically, this problem has been addressed by providing plywood sheets to increase the fixing strength of the panel. In this case, the plywood sheet is provided on the side of the panel opposite to that on which the fixture is to be located. The plywood sheet may provide increased strength for retaining one or more fixing means (e.g. screws) employed to secure the fixture to the panel. Typically, the plywood sheet is attached directly to the building framework, and the plasterboard then fixed to the plywood.

As an alternative, metal support means may be provided. These may comprise fixing plates, channels, straps, or metal fasteners. As is the case for plywood sheets, the metal support means are generally positioned on the side of the panel opposite that to which the fixture is to be secured, and act to receive and secure fixing means, e.g. fixing screws, that are used to attach the fixture to the panel.

Both these arrangements have the disadvantage that they require the additional supporting components to be affixed to the panel on-site. Moreover, when metal support means are used, a plurality of such support means may be needed to support the full set of fixing means required to secure the fixture to the panel. Thus, installation process may be time-consuming and expensive.

Furthermore, the addition of metal support means or plywood sheets increases the weight and thickness of the partition, and/or results in a reduction in cavity wall space. In general, the plywood itself must be cut to size on site, thus increasing the time required for installation and possibly leading to the release of dust and potentially harmful components.

Therefore, there is a need to provide improved panels that are able to retain fixing means and support fixtures, and that do not require time-consuming installation processes. In addition, it is desirable that such panels should be configured so as to simplify the process of their disposal once they reach the end of their useful lifetime. In fact, many countries have strict regulations governing the disposal of waste panels, with the result that the disposal of waste panels may be very expensive if the panels are not originally configured with these regulations in mind.

Therefore, at its most general, the present invention may provide a panel comprising a substrate board and a backing lamina, the lamina being reversibly secured to a surface of the substrate board.

The lamina may increase the fixing strength of the panel, without the need for time-consuming installation on site. Surprisingly, it has been found that this increase in fixing strength is not dependent on strength of the bond (if any) between the lamina and the substrate board. Thus, it is possible to provide a panel in which the substrate board and lamina may easily be separated at the end of the lifetime of the panel, so as to simplify the process of disposing of this waste, e.g. through recycling.

The lamina may be reversibly secured to the substrate board by mechanical means (e.g. clips). However, such mechanical means tend to increase the weight of the panel, and may also be time-consuming to install. Thus, it is preferred that the lamina is bonded to the substrate board e.g. by means of an adhesive.

Typically, the provision of a backing lamina on a substrate board results in a panel that is asymmetrical. That is, the configuration of the panel when viewed from a first face of the panel is different to the configuration when viewed from a second face of the panel.

Therefore, in a first aspect, the present invention may provide a panel for use in building construction, the panel comprising a substrate board having two opposed faces, wherein a backing lamina is secured to a first one of the faces of the substrate board by means of one or more regions of bonding between the lamina and the board, wherein the one or more regions of bonding cover a total area that is less than 20% of the total interfacial area between the lamina and the board.

The lamina represents a layer that provides a discrete component of the panel, that is, it is not integrally formed with the substrate. Effectively, there is a well-defined interface or boundary between the substrate and the lamina.

The one or more bonding regions provide a bond between the lamina and the substrate board, the strength of the bond being sufficient to allow for handling and installation of the panel, but also allowing the panel components to be separated readily e.g. when the building structure is dismantled. Surprisingly, it has been found that even incomplete bonding of the lamina and the substrate board (e.g. where bonding is present only across a fraction of the interface between the lamina and the board) may be sufficient to allow handling and installation of the panel, while still allowing the lamina and board to be detached from each other at the end of the useful lifetime of the panel.

Preferably, the one or more regions of bonding between the lamina and the board cover a total area that is less than 19% of the total interfacial area between the lamina and the board, more preferably less than 15%, most preferably less than 13%.

In general, the one or more regions of bonding form a pattern across the interface between the board and the lamina. For example, the bonding regions may be configured as stripes that are aligned with or transverse to a longitudinal direction of the board. In an alternative, the bonding regions may provide a two-dimensional array of dots.

Typically, the lamina is secured to the first one of the faces of the substrate board by means of a plurality of discrete regions of bonding between the lamina and the board. In this case, it is preferred that the maximum distance between nearest neighbour regions of bonding is 80 mm, preferably 60 mm, more preferably 40 mm. It is preferred that the distance between nearest neighbour regions of bonding should not be too great, because otherwise problems may arise during cutting of the panel.

The one or more regions of bonding may be provided by an adhesive located at the interface between the lamina and the substrate board. A wide range of adhesives have been found to be suitable for this use. For example, the adhesive may be selected from the group comprising low tack adhesives (for example, pressure-sensitive adhesives such as those comprising e.g. an elastomer and a tackifier such as a rosin ester), polyvinylacetate glue, ethylene vinyl acetate glue, polyvinyl alcohol based glue, viscoelastic glues, epoxy-based glues, and acrylic-based glues. Particular examples of suitable adhesives are Bostik™ 29860 and Bostik™ 4821D.

In the case that the one or more regions of bonding are provided by an adhesive, the extent of coverage of the adhesive is assessed after the lamina has been glued to the substrate board, that is, after the adhesive has been flattened through the action of bringing the lamina and the board together.

In certain embodiments of the invention, the lamina is selected such that it bonds to the substrate board without the need for adhesive (for example, the lamina may be formed from polymer resin that is deposited on the substrate board and subsequently allowed to cure). In such cases, incomplete bonding between the lamina and the board may be achieved by providing a partial barrier between the lamina and the board. For example, the barrier may comprise apertures or cut-outs. In such cases, bonding is limited to those regions of the panel where the substrate board and lamina are not separated by the barrier.

The barrier may comprise a coating that is applied to one of the substrate board and the lamina (the coating may be e.g. a hydrocarbon gel such as petroleum jelly). In other cases, the barrier may comprise a pre-formed mask that is placed between the board and the lamina.

Typically, the substrate board comprises plasterboard, that is, a board comprising gypsum plaster extruded between two paper or glass fibre sheets. Alternatively, the substrate board may comprise a polystyrene, phenolic foam, polyurethane foam, or cement board, glasswool batts or fibreboard.

Panels according to the first aspect of the invention typically demonstrate increased pull-out resistance relative to the substrate board alone, such that they are better able to support fixtures such as sinks or fire extinguishers. In fact, the pull-out resistance of the panels may be comparable to that of structures in which a plywood backing is applied to a substrate board, or in which metal fasteners are used to secure fixing means such as screws.

Furthermore, these levels of pull-out resistance may be achieved through the application of a relatively thin lamina, such that the overall weight of the panel is lower than that of conventional structures comprising plywood or metal fixtures. Thus, the strength/weight ratio of panels according to the first aspect of the invention may be higher than that of conventional structures. This feature may allow for improved manual handling of the panel during installation, and thus compliance with safety regulations may be achieved more straightforwardly. In addition, thinner panels may allow for a reduced footprint of a partition within a building structure and/or increased cavity space to be provided within the partition e.g. to accommodate pipes or insulation.

Moreover, panels are supplied with the strengthening lamina already attached to the substrate board. Thus, the number of steps required for installation of the panel may be reduced.

By providing an alternative to the use of plywood, the present invention may help to reduce the spread of e.g. mould or bacteria through a building, due to a reduction in the amount of foodstuff available for these organisms.

Typically, the lamina has a thickness of at least 0.25 mm, preferably at least 0.5 mm, more preferably at least 1 mm. Such thickness may provide the necessary stiffness to the lamina, such that it can improve the fixing strength of the panel.

Typically, the thickness of the lamina is less than 4 mm, preferably less than 3 mm, more preferably less than 2.5 mm. It is desirable to limit the thickness of the lamina so that when the panel is installed to provide e.g. a wall, its footprint within the building structure is not too great.

Typically, the thickness of the lamina is less than the thickness of the substrate board. Preferably, the thickness of the lamina is less than 25% of the thickness of the substrate board, more preferably less than 20%.

A typical panel may comprise a gypsum plasterboard of 10-20 mm thickness, and may have a total thickness of approximately 11-25 mm.

Typically, the lamina is solid and non-porous. This may assist in providing the lamina with the necessary stiffness to improve the fixing strength of the panel. The phrase “solid and non-porous” is intended to exclude laminae that comprise a 3-dimensional porous array. The phrase is not intended to exclude laminae that have apertures or perforations extending through the thickness of the lamina. For example, it is envisaged that the lamina may include a 2-dimensional distribution of through-thickness apertures.

In general, the lamina comprises a polymeric material. In such cases, the lamina may comprise a monolithic polymer (i.e. a unitary, non-composite material). Alternatively, the lamina may be a composite material e.g. a fibre-reinforced composite.

In the case that the lamina is a monolithic polymer, the lamina may comprise a thermoplastic polymer such as HDPE (high-density polyethylene), PVC (polyvinylchloride), polycarbonate or nylon. Alternatively, the lamina may comprise a thermosetting polymer such as Bakelite.

In the case that the lamina is a fibre composite, it is preferred that the fibres comprise the same material as the matrix, i.e. the lamina is a self-reinforced composite. An example of such a composite is a self-reinforced polypropylene composite in which both the fibres and the matrix consist of polypropylene, this composite being available under the trade name Curv™. The advantage of a self-reinforced composite is that it is generally easy to recycle, as the fibres do not need to be separated from the matrix. For example, a self-reinforced polypropylene composite may simply be melted down, when it has reached the end of its useful lifespan.

Where the fibres and the matrix are not formed from the same material, it is preferred that a fibre composite lamina has the following features.

Typically, the fibre composite lamina comprises a polymer resin matrix. Preferred components of the polymer resin are polyester, polyurethane, epoxy, melamine, or any combination thereof. In preferred embodiments, the polymer resin may be unsaturated polyester or epoxy.

Preferably, the polymer resin is a thermosetting resin, but in certain embodiments of the panel of the invention, the fibre composite lamina may comprise a thermoplastic resin.

The fibrous component of the fibre composite lamina may be provided e.g. in the form of one or more woven or unwoven mats. In the case that there are several mats, these are generally stacked to provide a layered array. As an alternative, the fibrous component may comprise randomly-oriented fibres, e.g. chopped fibres. In general, the chopped fibres have an average length of at least 40 mm. In general, the average length is less than 60 mm. Typically, the average fibre diameter is greater than 10 micron. Typically, the average fibre diameter is less than 15 micron.

The fibres may comprise principally glass (in particular E glass), carbon, aramid fibres such as Kevlar™, silica, silk, Nylon, hemp, flax, cellulose, or cotton. Preferably, the fibres are glass fibres.

Typically, the fibres comprise 15-60% by mass of the fibre composite lamina.

Preferably, the fibres comprise over 25% by mass of the fibre composite lamina, more preferably over 30% by mass. Preferably, the fibres comprise less than 50% by mass of the fibre composite lamina, more preferably less than 45%.

The panel according to the first aspect of the invention may further comprise an insulating layer, such as a foam layer (for example, phenolic foam), an expanded polystyrene layer, or a mineral wool layer. Typically in this case, the lamina is positioned between the substrate board and the insulating layer.

The panel may further comprise a metal layer, such as copper. The metal layer is typically provided on the opposite side of the lamina from the substrate board.

In a second aspect, the present invention may provide a method of manufacturing a panel according to the first aspect of the invention, comprising the steps of:
providing a substrate board having two opposed faces, and a lamina having two opposed faces;
applying an adhesive to a face of either the substrate board or the lamina, such that the adhesive partially covers the face; and
gluing the lamina to the substrate board by means of the adhesive;
wherein after the step of gluing the lamina to the substrate board, the adhesive covers less than 20% of the interfacial area between the lamina and the substrate board.

In certain embodiments of the invention, the lamina may be formed from a polymer resin that is deposited on the substrate board and allowed to cure. Therefore, in a third aspect, the present invention may provide a method of manufacturing a panel, comprising the steps of:
providing a substrate board having two opposed faces;
placing a partial barrier on one surface of the substrate board;
depositing a polymer resin on the barrier and allowing the resin to set to provide a polymer lamina.

The barrier may be a coating that is applied to the substrate board, e.g. a hydrocarbon gel such as petroleum jelly. In an alternative embodiment, the barrier may be a pre-formed mask that is laid on the substrate board.

Typically, the polymer resin is spread across the barrier using a roller, or sprayed onto the barrier. The method may include the additional step of levelling the polymer lamina provided by the polymer resin, to provide a smooth and level outer surface for the panel.

In certain cases, it may be desirable to provide a polymer lamina that comprises fibres. This may be done, for example, by incorporating fibres into the polymer resin before depositing it on the barrier. In an alternative example of this method, a fibre mat may be placed on the barrier before deposition of the polymer resin, such that the polymer resin impregnates the mat as it is deposited onto the barrier.

In this case, the method may comprise a further optional step of applying a compression force to the impregnated fibre mat, to increase uptake of the the polymer resin by the mat.

The panels manufactured according to the second, or third aspects of the invention may comprise one or more optional features of the panel according to first aspect of the invention.

In a fourth aspect, the present invention may provide a panel for use in building construction, the panel comprising a substrate board having two opposed faces, wherein a lamina is secured to a first one of the faces of the substrate board by means of one or more regions of bonding between the lamina and the board,
wherein the one or more regions of bonding cover a total area that is less than the total interfacial area between the lamina and the board, and further wherein at the one or more regions of bonding, the lamina is in direct contact with the substrate board.

In this aspect of the invention, the lamina is bonded directly to the substrate board, without the need e.g. for adhesive. Typically, the lamina is formed from a resin that is deposited on the substrate board and allowed to cure. In general, a partial barrier is provided between the substrate board and the lamina, the partial barrier serving to define the one or more regions of bonding. The partial barrier may be e.g. a coating applied to one of the substrate board and the lamina, or a pre-formed mask interposed between the substrate board and the lamina.

Typically, the one or more regions of bonding cover a total area that is less than 75% of the total interfacial area between the lamina and the board, preferably less than 60%, most preferably less than 40%.

The panel according to the fourth aspect of the invention may comprise one or more optional features of the panel according to the first aspect of the invention.

In a fifth aspect, the present invention may provide a method of manufacturing a panel comprising the steps of:
providing a substrate board having two opposed faces;
providing a viscous mixture of resin and fibre; and
spreading the viscous mixture of resin and fibre across one of the faces of the substrate board, to provide a fibre composite lamina.

Typically, the step of spreading the viscous mixture across one of the faces of the substrate board is carried out using a roller.

Certain advantageous features of the invention and the way it can be put into operation are now demonstrated in the following worked illustrative Examples.

### EXAMPLE 1

A masking template was placed on a Duraline™ gypsum board to provide a partial barrier on one face thereof. The masking template comprised circular apertures each having a diameter of 25 mm. Four circular apertures were provided per 150 mm×150 mm square area of board. That is, 8.72% of the face of the board was left uncovered by the masking template.

An additional supporting board was placed adjacent to the Duraline™ gypsum board and a complete barrier was positioned on its upwardly-facing surface.

A polyester resin (Crystic™ 2-414PA from Scott Bader) was deposited on the surface provided by the masking template and the complete barrier, and allowed to cure. The resin contained 300 g of chopped, non-woven glass fibres per square meter of board.

After curing of the resin, the additional supporting board and the complete barrier were separated from the Duraline™ gypsum board, so that a 30 mm wide strip of cured resin protruded from the Duraline™ gypsum board. An aperture was formed in the protruding strip to allow weights to be hung from it. The strength of the bond between the resin layer and the board was measured, as described below.

### EXAMPLE 2

Example 2 has the same features as Example 1, except that the masking template was configured to leave linear portions of the board surface exposed, rather than circular portions. That is, the widthways edge of the board had four exposed lines extending from it, per 150 mm of board edge. The width of each exposed line was 2.5 mm. Thus, 6.67% of the board was left uncovered by the masking template.

### COMPARATIVE EXAMPLE 3

Comparative Example 3 has the same features as Examples 1 and 2, except that no barrier was present. That is, there was direct contact between the polyester resin and the board across 100% of the interface between them.

Detachability Tests (Polyester Resin Samples)

Detachability tests were carried out on the sample of Examples 1 and 2, and Comparative Example 3 by placing each sample horizontally in a sample holder, such that the cured resin sheet faced downwardly. Weights were placed on the sample and the sample holder in order to stabilise them. A weight-attachment hook was hung from the aperture in the protruding part of the cured resin sheet, and weights were added to the hook in 100 g gram increments. A five second interval was maintained between successive increases of mass carried by the hook. Once the cured resin sheet had detached from the board, the failure weight was recorded and used to calculate the detachability as a function of the interfacial area between the cured resin sheet and the board. The results are given in Table 1:

TABLE 1

| Example | Detaching force (N × 10⁻³/mm²) |
|---|---|
| Example 1 | 2.2 |
| Example 2 | 2.2 |
| Comparative Example 3 | 3.0 |

### EXAMPLE 4

A dot pattern of Bostik Aquagrip™ glue was applied to one face of a Duraline™ gypsum board using a template. 35 dots of glue were applied in a rectangular array to a 150 mm×126 mm area of the board, the spacing of the dots being 25 mm×22 mm. The diameter of each dot was about 5 mm.

The glue pattern was used to secure an unsaturated polyester fibreglass sheet (supplied by Crane Composites Inc. Crane product reference: FCG180) to the board. The fibreglass sheet was positioned on the board such that a 30 mm strip of the sheet protruded from the board. This strip included an aperture to allow weights to be hung from the sheet. After allowing the panel to dry for at least 12 hours, the strength of the bond between the fibreglass sheet and the board was measured, as described below.

After separation of the fibreglass sheet and the board, the surface coverage of the glue was measured using pixel-counting software, and was found to be 18.6% of the interfacial area between the sheet and the board.

### EXAMPLES 5-9

Examples 5-9 have the same features as Example 4, except that the surface coverage of the glue, and in some cases also the number of dots, their diameter and their separation, was different. The values measured are shown in Table 2:

TABLE 2

| | Surface | Number of dots per | | |
|---|---|---|---|---|
| Exam- | coverage | 150 mm × 126 mm | Dot | Dot |
| ple | of glue | area of board | spacing | diameter |
| 5 | 19.0 | As for Example 4 | | |
| 6 | 9.3 | 20 | 30 mm × 30 mm | 5 mm |
| 7 | 12.6 | 20 | 30 mm × 30 mm | 5 mm |
| 8 | 19.7 | 20 | 30 mm × 30 mm | 6 mm |
| 9 | 17.2 | 20 | 30 mm × 30 mm | 6 mm |

### COMPARATIVE EXAMPLE 10

Comparative Example 10 has the same features as Examples 4-9, except that the glue extends along the whole interface between the fibreglass sheet and the board. Five samples were tested and the average strength of the bond between the fibreglass sheet and the board was calculated.

### Detachability Tests (Glued Samples)

Detachability tests were carried out on Examples 4-9 and Comparative Example 10 by placing each sample horizontally in a sample holder, such that the fibreglass sheet faced downwardly. Weights were placed on the sample and the sample holder in order to stabilise them. A weight-attachment hook was hung from the aperture in the protruding part of the sheet, and weights were added to the hook in 100 g gram increments. A five second interval was maintained between successive increases of mass carried by the hook. Once the fibreglass sheet had detached from the board, the failure weight was recorded and used to calculate the detachability as a function of the interfacial area between the fibreglass sheet and the board. The results are given in Table 3:

TABLE 3

| Example | Detaching force (N × 10⁻³/mm²) |
|---|---|
| Example 4 | 1.1 |
| Example 5 | 1.2 |
| Example 6 | 0.8 |
| Example 7 | 0.8 |
| Example 8 | 1.1 |
| Example 9 | 1.1 |
| Comparative | 3.2 (maximum recorded = 3.5; |
| Example 10 | minimum recorded = 2.9) |

Significant decreases in detaching force were observed as the glue coverage was reduced from full coverage of the interface between the fibreglass sheet and the board, to below 20% of the interface. Thus, in practice, the fibreglass sheets may easily be detached from the gypsum boards, for recycling purposes, while the bond between the two components is sufficiently strong to allow for handling and installation of the panel.

### COMPARATIVE EXAMPLE 11

A fibre composite lamina having the properties set out in Table 4 was glued to a 15 mm thick gypsum wallboard (Gyproc Duraline™) using a polyvinylacetate ethylene based glue (Bostik™ 29860)

TABLE 4

| | |
|---|---|
| Fibre | Woven E glass |
| Resin | Epoxy resin |
| Number of layers of woven fibres | 8 |
| Fibre content | 50 wt % |
| Resin content | 50 wt % |
| Thickness of composite lamina | 1.6 mm |

The fibre composite lamina has an additional copper layer on one face, for example, copper foil. It was glued to the wallboard such that the copper layer faces outwardly.

The fibre composite lamina is an FR4 laminate supplied by the Lamar Group.

### COMPARATIVE EXAMPLES 12-14

The panels of Comparative Examples 12-14 are the same as the panel of Comparative Example 11, except for the characteristics set out in Table 5.

TABLE 5

| Example | Difference relative to Comparative Example 11 |
|---|---|
| Comparative | There is no additional copper layer |
| Example 12 | |
| Comparative | Glue used is a viscoelastic glue (Weber ™ glue, supplied |
| Example 13 | by Weber, France); there is no additional copper layer |
| Comparative | Glue used is a viscoelastic glue, supplied by Saint Gobain |
| Example 14 | Performance Plastics; there is no additional copper layer |

### COMPARATIVE EXAMPLE 15

2.3 mm unsaturated polyester fibreglass sheet glued to 15 mm Gyproc Duraline board with Bostik 29860.

### COMPARATIVE EXAMPLE 16

1.6 mm composite unsaturated polyester fibreglass sheet (supplied by Crane Composites Inc. Crane product reference: ETG160) glued to 15 mm Gyproc Duraline board with Bostik 29860.

### COMPARATIVE EXAMPLE 17

2 mm composite fibreglass sheet glued to 15 mm Gyproc Duraline board with Bostik 29860.

### COMPARATIVE EXAMPLE 18

1.8 mm unsaturated polyester fibreglass sheet (supplied by Crane Composites Inc. Crane product reference: FCG180), glued to 15 mm Gyproc Duraline board with Bostik 29860.

### COMPARATIVE EXAMPLE 19

A 2 mm self-reinforced polypropylene sheet (available under the trade name Curv™) was secured to a 12.5 mm gypsum wallboard using Bostik™ 29860 glue.

### COMPARATIVE EXAMPLE 20

A 2 mm HDPE sheet was secured to a 12.5 mm gypsum wallboard using Bostik™ 29860 glue.

### COMPARATIVE EXAMPLE 21

A 2 mm PVC sheet was secured to a 12.5 mm gypsum wallboard using Bostik™ 29860 glue.

### COMPARATIVE EXAMPLE 22

A 2 mm polycarbonate sheet was secured to a 12.5 mm gypsum wallboard using Bostik™ 29860 glue.

### COMPARATIVE EXAMPLE 23

A 2 mm nylon sheet was secured to a 12.5 mm gypsum wallboard using Bostik™ 29860 glue.

### COMPARATIVE EXAMPLE 24

A 2 mm Bakelite sheet was secured to a 12.5 mm gypsum wallboard using Bostik™ 29860 glue.

### COMPARATIVE EXAMPLE 25

A 12.5 mm spruce plywood laminate, having 7 leaves, was secured to a 15 mm gypsum wallboard (Gyproc Duraline™) using Bostik™ 29860 glue.

### COMPARATIVE EXAMPLE 26

A 12.5 mm spruce plywood glued to a 15 mm gypsum wallboard (Gyproc Duraline™)

### COMPARATIVE EXAMPLE 27

A 12.5 mm spruce plywood and a 15 mm gypsum wallboard (Gyproc Duraline™), held together through mechanical means, rather than adhesive.

### COMPARATIVE EXAMPLE 28

12.5 mm thickness Rigidur™ gypsum fibreboard.

### COMPARATIVE EXAMPLE 29

0.6 mm thick steel plate was glued to a Gyproc Duraline™ board using Bostik™ 29860 polyvinylacetate glue.

### COMPARATIVE EXAMPLE 30

The panel of Comparative Example 30 is the same as the panel of Comparative Example 12, except that the plasterboard and composite are held together through mechanical means, rather than being bonded by an adhesive.

Pull-Out Tests

Pull-out tests were carried out using a Gyproc drywall screw having a shaft of 3 mm diameter. Before starting the pull-out test, the screw is inserted into the board such that 5-15 mm of the screw extends from the rear face of the board. The test speed is 4.45 N/s. The results are given in Table 6. The pull-out force is the peak failure load.

TABLE 6

| | | Pull-out force normalised |
|---|---|---|
| Example | Pull-out force (N) | by weight (N per kg/m²) |
| Comparative Example 11 | 1293 | 341 |
| Comparative Example 19 | 1193.8 | — |
| Comparative Example 20 | 639.3 | — |
| Comparative Example 21 | 898.6 | — |
| Comparative Example 22 | 888.9 | — |
| Comparative Example 23 | 691.8 | — |
| Comparative Example 24 | 717.2 | — |
| Comparative Example 25 | 1301 | 157 |
| Comparative Example 26 | 1458 ± 111.8 | — |
| Comparative Example 27 | 1439 ± 139.9 | — |
| Comparative Example 28 | 640 | 412 |
| Comparative Example 29 | 1227 | 213 |
| Comparative Example 30 | 1257 | 329 |

The panel of Comparative Example 11 (gypsum board+fibreglass lamina) has a comparable screw pull-out strength to Comparative Examples 25 (gypsum board+plywood) and 29 (gypsum board+steel plate), while demonstrating a considerable increase over Comparative Example 28 (gypsum board alone). When normalised by weight, the pull-out strength of Comparative Example 11 is significantly higher than that of the Comparative Example 25, 28 and 29).

The panels of Comparative Example 11 and Comparative Example 30 have a similar pull-out strength, demonstrating that unglued panels may achieve the same performance as glued panels.

1. A panel for use in building construction, the panel comprising a substrate board having two opposed faces, wherein a lamina is secured to a first one of the faces of the substrate board by means of one or more regions of bonding between the lamina and the board, wherein the one or more regions of bonding cover a total area that is less than 20% of the total interfacial area between the lamina and the board.

2. A panel according to claim 1, wherein the lamina is secured to the first one of the faces of the substrate board by means of a plurality of discrete regions of bonding between the lamina and the board.

3. A panel according to claim 2, wherein the maximum distance between nearest neighbor regions of bonding is 80 mm.

4. A panel according to claim 1, wherein the one or more regions of bonding are provided by an adhesive located at the interface between the lamina and the substrate board.

5. A panel according to claim 1, wherein a barrier is provided between the substrate board and the lamina, the barrier providing incomplete separation of the board and the lamina, so as to allow partial bonding between the board and the lamina.

6. A panel according to claim 5, wherein the barrier is a coating applied to one of the substrate board and the lamina.

7. A panel according to claim 5, wherein the barrier is a pre-formed mask provided between the substrate board and the lamina.

8. A panel according to claim 1, wherein the thickness of the fibre composite lamina is less than the thickness of the substrate board.

9. A panel according to claim 1, wherein the substrate board comprises a gypsum plasterboard.

10. A panel according to claim 1, wherein the lamina comprises a polymeric material.

11. A panel according to claim 1, wherein the lamina is a fibre composite.

12. A method of manufacturing a panel according to claim 1, comprising the steps of:
providing a substrate board having two opposed faces, and a lamina having two opposed faces;
applying an adhesive to a face of either the substrate board or the lamina, such that the adhesive partially covers the face; and
gluing the lamina to the substrate board by means of the adhesive;
wherein after the step of gluing the lamina to the substrate board, the adhesive covers less than 20% of the interfacial area between the lamina and the substrate board.

13. A method of manufacturing a reinforced panel, comprising the steps of:
providing a substrate board having two opposed faces;
placing a barrier on a first surface of the substrate board, the barrier providing incomplete coverage of the first surface of the substrate board;
depositing a polymer resin on the barrier and allowing the resin to set to provide a polymer lamina.

14. A method according to claim 13, wherein the barrier is a coating applied to the substrate board.

15. A method according to claim 13, wherein the barrier is a pre-formed mask that is laid on the substrate board.

16. A method according to claim 13, further comprising the step of spreading the polymer resin across barrier using a roller.

17. A method according to claim 13, wherein the polymer resin that is provided for deposition on the barrier contains fibres.

18. A method according to claim 13, comprising the further step, prior to the step of depositing the polymer resin on the barrier, of placing a fibre mat on the barrier, such that the polymer resin impregnates the fibre mat during the step of depositing the polymer resin on the barrier.

19. A panel for use in building construction, the panel comprising a substrate board having two opposed faces, wherein a lamina is secured to a first one of the faces of the substrate board by means of one or more regions of bonding between the lamina and the board,
wherein the one or more regions of bonding cover a total area that is less than the total interfacial area between the lamina and the board, and further wherein at the one or more regions of bonding, the lamina is in direct contact with the substrate board.

20. A method of manufacturing a panel comprising the steps of:
providing a substrate board having two opposed faces;
providing a viscous mixture of resin and fibre; and
spreading the viscous mixture of resin and fibre across one of the faces of the substrate board, to provide a fibre composite lamina.

21. A method according to claim 20, wherein the step of spreading the viscous mixture across one of the faces of the substrate board is carried out using a roller.
